(19) United States
(12) Patent Application Publication
(10) Pub. No.: US 2020/0281425 A1
(43) Pub. Date: Sep. 10, 2020

(54) Suction Apparatus

(71) Applicant: Robert Bosch GmbH, Stuttgart (DE)

(72) Inventors: Dietmar Saur, Moessingen (DE); Tim Hartmann, Fellbach (DE)

(21) Appl. No.: 16/650,219

(22) PCT Filed: Sep. 12, 2018
(86) PCT No.: PCT/EP2018/074615

§ 371 Date: Mar. 24, 2020

(30) Foreign Application Priority Data
Sep. 29, 2017 (DE) 10 2017 217 424.2

(51) Int. Cl. A47L 7/00; A47L 9/24; A47L 9/28; A47L 5/36; G05D 16/20

(52) U.S. Cl. CPC A47L 7/0095; A47L 9/248; A47L 9/2805; G05D 16/2066; A47L 9/2894; A47L 5/365; A47L 9/2842

(57) ABSTRACT

A suction apparatus includes a suction apparatus housing, a suction hose, at least one suction apparatus communication unit, and at least one sensor device which comprises at least one sensor unit designed to detect at least one operating signal of a machine tool, in particular of a handheld machine tool. The suction hose is assigned the at least one sensor device. The at least one sensor device has at least one signal processing unit and at least one sensor device communication unit. The signal processing unit is designed to receive the operating signal from the sensor unit and process said operating signal into at least one communication signal, and the sensor device communication unit is provided to establish at least one communication connection to the suction apparatus communication unit and to transmit the communication signal to the suction apparatus communication unit.

The present invention relates to a suction apparatus having a suction apparatus housing, having a suction hose, having at least one suction apparatus communication unit and having at least one sensor device.

### PRIOR ART

JP 2001 179705 A2 has already disclosed a dust collecting machine having a dust collecting machine housing and having a dust collecting hose, wherein the dust collecting hose is fitted to the dust collecting machine housing. The dust collecting machine housing comprises a dust collecting machine motor and also a dust collecting space. The dust collecting motor is provided for generating a suction flow and the dust collecting space is provided for collecting segregated particles from the suction flow. For this purpose, the dust collecting machine sucks up particles via the dust collecting hose. The dust collecting machine is supplied with electrical energy by an electrical energy store. The electrical energy can be made available by a rechargeable battery, but also by means of power supply system operation, for example by means of a 230 V power supply system. The dust collecting hose has a microphone in order to identify operating signals, in particular operating noise or operating vibrations, of a connected electric tool and to transmit them to a dust collecting machine control unit. The dust collecting machine control unit then switches the dust collecting machine on or off.

### DISCLOSURE OF THE INVENTION

The present invention proceeds from a suction apparatus having a suction apparatus housing, having a suction hose and having at least one suction apparatus communication unit. The suction hose is able to be fitted, in particular releasably, to the suction apparatus housing. In addition, the suction apparatus comprises at least one sensor device, wherein the at least one sensor device is assigned to the suction hose. The at least one sensor device comprises at least one sensor unit configured to detect at least one operating signal of a machine tool, in particular of a handheld machine tool. It is proposed that the at least one sensor device has at least one signal processing unit and at least one sensor device communication unit. The at least one signal processing unit is configured to receive the at least one operating signal from the at least one sensor unit and to process it into at least one communication signal. The at least one sensor device communication unit is provided for providing at least one communication connection to the at least one suction apparatus communication unit and for communicating the at least one communication signal to the at least one suction apparatus communication unit.

On account of the at least one sensor device at the suction hose of the suction apparatus, the invention makes it possible to provide an autostart function for machine tools, in particular handheld machine tools, independently of whether the suction apparatus has a suction apparatus power supply system connector socket on the suction apparatus housing. The autostart function in the case of power supply system-operated suction apparatuses having the suction apparatus power supply system connector socket on the suction apparatus housing is sufficiently known from the prior art. In the case of power supply system-operated suction apparatuses, a power supply system-operated electric machine tool can be connected to the suction apparatus power supply system connector socket. The autostart function enables the power supply system-operated suction apparatus to start automatically as soon as a load-dependent current is present at the suction apparatus power supply system connector socket. Said load-dependent current is present as soon as the power supply system-operated electric machine tool is being operated. The functioning of the autostart function in the case of power supply system-operated suction apparatuses having the suction apparatus power supply system connector socket, in particular with the use of the power supply system-operated electric machine tool, is sufficiently known to the person skilled in the art, for which reason it will not be discussed in greater detail here. In contrast to the prior art, the present invention yields the solution to the problem of enabling the autostart function for machine tools, such as, for example, rechargeable battery-operated, power supply system-operated or pneumatically operated machine tools, in particular handheld machine tools, independently of an energy supply of the machine tool. The suction apparatus according to the invention is therefore usable universally with substantially any machine tool, in particular handheld machine tool. In the context of the present invention, “universally” means that the suction apparatus according to the invention provides the autostart function independently of a machine tool manufacturer and independently of a specific energy supply of the machine tool. The suction apparatus according to the invention is thus compatible and usable for substantially any machine tool.

The suction hose has at least one suction opening and is able to be fitted, preferably releasably to the suction apparatus housing. The at least one suction opening is configured to take up particles obtained by means of a suction flow during operation of the suction apparatus. Moreover, the suction hose is connectable, preferably releasably connectable, to the machine tool, in particular the handheld machine tool. In this case, the suction hose is configured, during the operation of the machine tool, to transport the obtained particles, in particular dirt particles, away from a working surface, a working region or a working zone of the machine tool via the suction opening. For transporting away obtained particles by means of the suction hose, the suction apparatus is in operation. The at least one sensor device is assigned to the suction hose. In this case, the at least one sensor device is preferably arranged, in particular fitted, at an end region of the suction hose facing away from the suction apparatus. Particularly preferably, the at least one sensor device is arranged in proximity to the at least one suction opening. The at least one sensor device is advantageously fitted on the suction hose and mechanically connected thereto. In the context of the present invention, “mechanically connected” means that a force-locking, positively locking and/or cohesive connection is involved, wherein the latter can be configured as releasable or nonreleasable. A mechanical connection by means of securing means, preferably screws, is involved in this configuration. Alternatively, a clamping connection and/or a latching connection is also conceivable for the at least one sensor device at the suction hose, with the task of securing the at least one sensor device to the suction hose. In a further configuration of the invention, it is conceivable for the at least one sensor device to be able to be fitted to the suction hose releasably by means of a plug connection and an associated plug device and/or a hook and loop connection. In addition, it is conceivable for the at least one sensor device to be arranged in the suction hose, in particular in a jacket of the suction hose. Here the designation “in a jacket of the suction hose” should be understood to mean integrated in the jacket of the suction hose, such that the at least one sensor device is enclosed at least partly, in particular substantially entirely, by a material of the suction hose. Furthermore, it is possible for the at least one sensor device to be inside the suction hose, such that the suction flow directly flows around the at least one sensor device.

The at least one suction apparatus communication unit is assigned to the suction apparatus housing, wherein the at least one suction apparatus communication unit is preferably arranged inside the suction apparatus housing. However, it is also conceivable for the at least one suction apparatus communication unit also to be fitted to the suction apparatus housing or to be arranged outside the suction apparatus housing. The at least one suction apparatus communication unit is at least one communication unit of the suction apparatus.

In the context of the present invention, the at least one communication unit is configured to transmit and/or to receive communication signals. The communication signals can be transferred in a line-linked manner, via a wire connection or else via conductor tracks on a printed circuit board, and/or the communication signals can be communicated in a wireless manner. In this case, a wireless communication of the communication signals can be in the form of Bluetooth, WLAN, infrared, near field communication (NFC) by means of RFID technology, and also further wireless communications of the communication signals that are familiar to the person skilled in the art. Communication protocols used in this case may be Bluetooth Smart, GSM, UMTS, LTE, ANT, ZigBee, LoRa, SigFox, NB-IoT, BLE, IrDA, and also further communication protocols familiar to the person skilled in the art.

Preferably, the suction apparatus, in particular the at least one suction apparatus communication unit, is line-linked to the at least one sensor device. In this case, at least one line for line linking between the suction apparatus and the at least one sensor device is preferably arranged on the suction hose. Alternatively, it is conceivable for the at least one line to be arranged in the jacket of the suction hose or inside the suction hose, such that the suction flow directly flows around the at least one line. Here the designation “in a jacket of the suction hose” should be understood to mean integrated in the jacket of the suction hose, such that the at least one line is enclosed at least partly, in particular substantially entirely, by the material of the suction hose. In this case, the at least one line comprises at least one communication line and/or at least one energy supply line. The at least one communication line is configured to transport the at least one communication signal between the at least one sensor device and the suction apparatus. The at least one energy supply line is provided for supplying the at least one sensor device with energy, in particular electrical energy. It is conceivable for the at least one communication line also to comprise the at least one energy supply line, such that substantially at least one individual line is arranged between the at least one sensor device and the suction apparatus at the suction hose. In addition, it would also be possible for the at least one energy supply line to comprise the at least one communication line. In an alternative embodiment, the at least one line can additionally also comprise at least one data line. The at least one data line is then provided for transporting data packets between the at least one sensor device and the suction apparatus, in particular the at least one suction apparatus communication unit. This enables a reliable and secure connection between the at least one sensor device and the suction apparatus.

Advantageously, the suction apparatus housing has at least one mechanical interface and at least one communication interface. The at least one mechanical interface substantially connects the suction hose to the suction apparatus housing in a releasable manner. This is done by means of a force-locking and/or positively locking connection. Preferably, for this purpose, the suction hose has at least one locking unit which establishes the force-locking and/or positively locking connection of the suction hose to the suction apparatus housing by means of the at least one mechanical interface. The configuration of the at least one locking unit for a suction hose is sufficiently known to the person skilled in the art, for which reason it will not be discussed in any greater detail here. The at least one communication interface substantially connects at least the at least one sensor device to the at least one suction apparatus communication unit. For this purpose, the at least one sensor device is connected to the at least one communication interface by means of the at least one line, in particular the at least one communication line. Preferably, the at least one communication line is connected to the at least one communication interface in a releasable manner, for example by means of at least one plug connection, at least one clamping connection, at least one screw connection, at least one bayonet connection or further releasable connections between the at least one communication line and the at least one communication interface that appear to be expedient to the person skilled in the art. In addition, the at least one communication interface is connected, in particular line-linked, to the at least one suction apparatus communication unit. It is conceivable for the at least one communication interface to be connected to the at least one suction apparatus communication unit in a wireless manner. Preferably, the at least one communication interface has at least one energy supply interface for the at least one energy supply line. The at least one energy supply interface is configured to connect the at least one sensor device to at least one suction apparatus energy supply unit by means of the at least one energy supply line. It is conceivable for the at least one communication interface to comprise the at least one energy supply interface or for no energy supply interface to be provided if the at least one sensor device is not supplied with energy via the at least one suction apparatus energy supply unit. In addition, the at least one communication interface can comprise at least one data interface for the at least one data line. The at least one data interface is then designed to connect the at least one data line to the at least one suction apparatus communication unit. Consequently, firstly a reliable connection of the suction hose and the suction apparatus is provided and an interference-free transfer of the at least one communication signal is also made possible.

In one preferred configuration, the at least one sensor device has at least one sensor device energy supply unit configured to supply the at least one sensor device with energy. For this purpose, the at least one sensor device energy supply unit is advantageously connected to the at least one energy supply line, such that the at least one sensor device energy supply unit is supplied with energy, in particular electrical energy, via the at least one suction apparatus energy supply unit. It is also conceivable for the at least one sensor device energy supply unit to be supplied with electrical energy via at least one battery, in particular at least one button cell, via at least one rechargeable battery unit, or by means of energy harvesting. The configuration of the at least one sensor device energy supply unit by means of the at least one battery, the at least one rechargeable battery unit or energy harvesting is sufficiently known to the person skilled in the art, for which reason it will not be discussed in any greater detail here.

The at least one sensor device comprises at least one sensor unit designed to detect the at least one operating signal of the machine tool, in particular of the handheld machine tool. The at least one sensor unit is preferably configured as at least one acceleration sensor which detects the at least one operating signal of the machine tool, in particular the vibrations thereof during operation. Preferably, the at least one acceleration sensor substantially detects at least acceleration values in at least one spatial direction. Especially preferably, the at least one acceleration sensor substantially detects at least acceleration values in at least three spatial directions. In order that the at least one sensor unit can detect the at least one operating signal, the at least one sensor unit is connected to the machine tool by means of the suction hose. In particular, the at least one acceleration sensor detects substantially all movements that occur by means of a spring-mass oscillatory system, for example. The at least one acceleration sensor thus detects deflections relative to a manufacturer-stipulated comparison level, such as a zero state, for example, in the at least one spatial direction, in particular the at least three spatial directions, and over a predefined operating time.

It is also possible for the at least one sensor unit to be at least one rate-of-rotation sensor which detects at least one rate of rotation of the machine tool. Furthermore, it is also conceivable for the at least one sensor unit to be at least one acoustic sensor, in particular at least one microphone, which detects at least one operating sound of the machine tool. The at least one operating sound is generated by the machine tool as soon as the machine tool is being operated. In an alternative configuration, at least one magnetic field sensor is conceivable for the at least one sensor unit. The at least one magnetic field sensor detects at least one magnetic field of the machine tool as soon as the latter is being operated. In addition, it is conceivable for the at least one sensor unit to be configured as at least one position sensor which detects at least one position of the machine tool as soon as the suction hose is connected to the machine tool. In addition, at least one motion sensor is possible as the at least one sensor unit, said at least one motion sensor detecting at least one motion of the machine tool when it is connected to the machine tool by means of the suction hose.

The machine tool, in particular the handheld machine tool, generates the at least one operating signal during its operation. In this case, the at least one operating signal can comprise the at least one vibration, caused by a rotation of a machine tool motor and/or processing of a workpiece. In addition, the at least one operating signal can be at least one rate of rotation, in particular at least one partial rotation, of the machine tool, the at least one operating sound, in particular at least one acoustic sound, or the at least one magnetic field of the machine tool during operation. Alternatively, the at least one operating signal can be the at least one position or the at least one motion of the machine tool. Examples of machine tools in this case are a circular saw bench, a belt grinder, a bench planer and further machine tools that appear to be expedient to the person skilled in the art. In this case, examples of handheld machine tools are a screwdriver, in particular a rechargeable battery screwdriver or a power supply system-operated screwdriver, a rotary impact screwdriver, a plasterboard screwdriver, a percussion drill, a hammer drill, a core drill, an angle grinder, a random orbital sander, an orbital sander, a jigsaw, a demolition hammer, a handheld circular saw, a hand plane or further handheld machine tools that are sufficiently known to the person skilled in the art.

According to the invention, the at least one sensor device additionally comprises the at least one signal processing unit and also the at least one sensor device communication unit. The at least one signal processing unit is designed to receive the at least one operating signal which was detected by the at least one sensor unit from the machine tool, in particular handheld machine tool. Afterward, the at least one signal processing unit processes the at least one operating signal into the at least one communication signal, for example by means of at least one microprocessor and/or at least one microcontroller. The at least one communication signal is based on at least one operating state of the machine tool, in particular of the handheld machine tool, such as, for example, switched on or switched off, or at least one filtered signal derived from the at least one operating signal. Furthermore, the at least one signal processing unit is designed to transmit, in particular to communicate in a line-linked manner, the at least one communication signal to the at least one sensor device communication unit.

In a manner according to the invention, the at least one sensor device communication unit is provided for providing the at least one communication connection to the at least one suction apparatus communication unit and for communicating the at least one communication signal to the at least one suction apparatus communication unit. The at least one sensor device communication unit is at least one communication unit of the at least one sensor device, as at least one communication unit of the type described in the introduction. The at least one sensor device communication unit is additionally designed to receive the at least one communication signal from the at least one signal processing unit. The at least one communication connection is preferably established in a line-linked manner, in particular by means of the at least one communication line. The at least one communication connection then connects the at least one sensor device communication unit to the at least one suction apparatus communication unit via the at least one communication interface, such that at least one one-way communication flow takes place, wherein at least one two-way communication flow would also be possible. In the context of the present invention, “one-way communication flow” means that the at least one communication signal is communicated from the at least one sensor device communication unit to the at least one suction apparatus communication unit and there is substantially no communication from the at least one suction apparatus communication unit to the at least one sensor device communication unit. “Two-way communication flow” should be understood to mean a bidirectional communication between the at least one sensor device communication unit and the at least one suction apparatus communication unit, such that at least one communication signal is communicated from the at least one sensor device communication unit to the at least one suction apparatus communication unit and also at least one suction apparatus communication signal is transferred from the at least one suction apparatus communication unit to the at least one sensor device communication unit. In this case, the at least one suction apparatus communication signal can comprise at least one operating signal of the suction apparatus. The at least one sensor device communication unit then communicates the at least one communication signal to the at least one suction apparatus communication unit via the at least one communication connection via the at least one communication line. In another embodiment, it is also conceivable for the at least one communication connection to be configured in a wireless manner.

The at least one sensor device thus comprises the at least one sensor unit, the at least one signal processing unit, the at least one sensor device communication unit and the at least one sensor device energy supply unit. In this case, these elements can preferably be arranged inside one sensor device housing or alternately inside a plurality of sensor device housings. Furthermore, these elements can be arranged in an advantageous manner on at least one printed circuit board, such that they are connected to one another by means of conductor tracks, wherein it is also conceivable for these elements to be connected to one another in a wired manner if they are not arranged on the at least one printed circuit board. In a preferred manner, the at least one sensor unit is line-linked to the at least one signal processing unit, in particular is arranged on at least the same printed circuit board, such that the at least one operating signal is communicated directly and immediately from the at least one sensor unit to the at least one signal processing unit. As described in the introduction, the at least one signal processing unit processes the at least one operating signal into the at least one communication signal. Afterward, the at least one communication signal is forwarded preferably by means of conductor tracks from the at least one signal processing unit to the at least one sensor device communication unit, since preferably the at least one sensor device communication unit is arranged on the same printed circuit board as the at least one signal processing unit. Alternatively, the at least one signal processing unit and the at least one sensor device communication unit are configured in a wired manner. In an alternative embodiment, it is conceivable for the elements of the at least one sensor device also to be connected to one another in a wireless manner.

Advantageously, the at least one sensor device has at least one operational control unit, wherein the at least one operational control unit comprises at least one operational control element and/or a display element. In this case, the at least one operational control unit of the at least one sensor device is designed to be operationally controlled by a user. Furthermore, the at least one operational control unit of the at least one sensor device is configured to provide and to display at least one operating state and/or at least one operating parameter and/or at least one item of operating information of the at least one sensor device and/or of the suction apparatus for the user. It is also possible for the at least one operational control unit of the at least one sensor device to display the at least one operating state of the machine tool. In addition, the at least one operational control unit of the at least one sensor device can be provided for altering operating states and/or operating parameters of the at least one sensor device and/or of the suction apparatus, in particular for controlling the at least one sensor device and/or the suction apparatus by open-loop and/or closed-loop control. Preferably, the at least one operational control unit of the at least one sensor device is assigned to the at least one sensor device housing, in particular is arranged on the at least one sensor device housing. Preferably, the at least one operational control unit of the at least one sensor device is arranged on at least one side of the sensor device housing.

An operational control element, in particular of the at least one sensor device, can be configured as at least one pushbutton element, as at least one sliding element, as at least one rotary element or else as at least one toggle element. Further embodiments of the at least one operational control element are also conceivable. The at least one pushbutton element is configured to be pressed by a user. The at least one sliding element is provided for being displaced by a user. The at least one rotary element is configured to be rotated by a user. The at least one toggle element is provided for being toggled by a user. Depending on the embodiment, a combination of the operational control elements mentioned is also possible.

A display element, in particular of the at least one sensor device, is configured to display operating states and/or operating parameters and/or items of operating information. Examples of a display element are at least one LED or at least one display, or further display elements that appear to be expedient to the person skilled in the art. In this case, the operating states can be for example “switched on”, “switched off”, “automatic operating mode” or “autostart”. The operating parameters are for example at least one rotational speed, at least one capacity, in particular at least one suction capacity, at least one threshold value for at least one sensitivity of the at least one sensor device. Examples of the items of operating information are “pairing with an electrical apparatus”, “connected to an electrical apparatus”, “not connected to an electrical apparatus”, at least one battery state of charge, of the at least one sensor device, of the suction apparatus or of the machine tool, in particular handheld machine tool. In addition, further examples of operating states, operating parameters and/or items of operating information that appear to be expedient to the person skilled in the art are also possible.

The at least one operational control unit of the at least one sensor device increases the operational control convenience for the user and enables simple and direct handling of the at least one sensor device for the user.

In a manner known per se, the suction apparatus comprises in particular a suction apparatus drive, the at least one suction apparatus energy supply unit, a dust collecting device and a suction apparatus controller. The details and the action of the suction apparatus drive, the suction apparatus energy supply, the dust collecting device and the suction apparatus controller are sufficiently known to the person skilled in the art.

Preferably, the suction apparatus is a rechargeable battery-operated suction apparatus which is operable by means of at least one rechargeable battery, in particular by means of a handheld machine tool rechargeable battery pack. As a result, the provision of the energy by the at least one suction apparatus energy supply unit is then effected by means of the at least one rechargeable battery. In the context of the present invention, a “handheld machine tool rechargeable battery pack” should be understood to mean an aggregation of at least one rechargeable battery cell and a rechargeable battery pack housing. The handheld machine tool rechargeable battery pack is advantageously configured for supplying energy to commercially available rechargeable battery-operated handheld machine tools. The at least one rechargeable battery cell can be configured for example as an Li-Ion rechargeable battery cell having a rated voltage of 3.6 V. By way of example, the handheld machine tool rechargeable battery pack comprises at least five rechargeable battery cells and a total rated operating voltage of 18 V in order to enable performance-conforming operation of the suction apparatus. Alternatively, the suction apparatus can be a power supply system-operated suction apparatus which is connectable to an external power supply system connector socket by means of a power supply cable. In this case, the external power supply system connector socket can provide a voltage of, for example, 100 V, 110 V, 120 V, 127 V, 220 V, 230 V or 240 V at 50 Hz or 60 Hz, but also a three-phase AC voltage. The possible configurations of the external power supply system connector socket and the available voltages associated therewith are sufficiently known to the person skilled in the art.

Furthermore, the suction apparatus housing can have at least one suction apparatus operational control unit and at least one suction apparatus holding unit. It is also possible for the suction apparatus housing to comprise at least one suction apparatus power supply system connector socket, such that a connected electrical apparatus is supplied with energy when the suction apparatus itself is supplied with energy. The suction apparatus operational control unit comprises at least one suction apparatus operational control element configured to be operationally controlled by a user and to generate switching signals. The switching signals then control the suction apparatus drive. The at least one suction apparatus operational control element can be arranged on one side of the suction apparatus housing. Suction apparatus operational control elements can be, for example, a main switch or a setting switch. The main switch is provided for switching the suction apparatus drive on and off or for changing it to the autostart function. The setting switch is configured to set a suction capacity of the suction apparatus. The at least one suction apparatus operational control element is an operational control element of the suction apparatus, in particular an operational control element as described above.

The suction apparatus holding unit comprises at least one suction apparatus holding element, for example a suction apparatus handle, by means of which the user can hold the suction apparatus. In addition, at least one suction apparatus movement unit can be fitted to the suction apparatus housing, such that the suction apparatus is expediently a mobile suction apparatus. The at least one suction apparatus movement unit is configured as at least one roller, at least as a wheel or the like, in order that it can be moved on a base.

Preferably, the mobile suction apparatus is configured as a portable suction apparatus having rollers, wheels or the like or else having no rollers, wheels or the like. In the context of the present invention, the user can carry the suction apparatus and use it directly at a desired site of use.

The at least one sensor device detects the at least one operating signal by means of the at least one sensor unit, wherein the at least one signal processing unit processes the at least one operating signal into the at least one communication signal.

In a first embodiment of the invention, the at least one signal processing unit is additionally configured to convert the at least one operating signal into at least one evaluation signal by means of at least one evaluation unit. The at least one evaluation unit is provided for forwarding the at least one evaluation signal as the at least one communication signal to the at least one sensor device communication unit. The at least one signal processing unit comprises the at least one evaluation unit, wherein the at least one evaluation unit is arranged substantially in the signal processing unit.

The at least one sensor unit communicates the at least one operating signal directly and immediately to the at least one signal processing unit. The at least one operating signal is subsequently processed within the signal processing unit, in particular in the at least one evaluation unit, by means of a microprocessor and/or microcontroller, for example. In an at least first evaluation step, at least substantially the at least one operating signal is filtered by means of at least one bandpass filter, for example. Possible interference variables which may be at least partly contained in at least one operating signal are substantially filtered here in order to enable a further evaluation. Possible interference variables which can influence the quality of the at least one operating signal are, for example, influences from a working environment of the user, influences arising from the user himself/herself, influences arising from the suction apparatus or further interference variables which appear to be meaningful for the person skilled in the art and which influence the quality of the at least one operating signal. In particular, interference variables are substantially movements which result in an acceleration value and are produced by the operation of the connected machine tool, such as, for example, movements of the machine tool and/or of the suction apparatus, vibrations and/or transport of the machine tool and/or of the suction apparatus. For the case where the at least one operating signal contains negative signal values, the absolute value of the at least one operating signal is formed in an at least second evaluation step, such that the at least one operating signal comprises substantially positive signal values. Afterward, in an at least third evaluation step, the at least one operating signal is at least partly smoothed. The smoothing of the at least one operating signal in the at least third evaluation step is carried out by means of the moving average method. The at least one operating signal is then processed into the at least one evaluation signal in an at least fourth evaluation step by means of an algorithm, such as a Schmitt trigger, for example. A conversion of the at least one operating signal into the at least one evaluation signal is therefore made possible. The at least one evaluation signal is thereupon forwarded as the at least one communication signal to the at least one sensor device communication unit. The at least one evaluation signal comprises at least substantially information about the at least one operating state and/or the at least one operating parameter of the machine tool, in particular of the handheld machine tool, in a data-reduced form. In particular, the at least one evaluation signal comprises the information about the machine tool “switched on” or “switched off”. The at least one evaluation signal is thus at least one evaluated operating signal.

As a result, fast and efficient signal processing is made possible and the working speed is increased. In an alternative embodiment, it is conceivable to carry out a different order of the evaluation steps in order to arrive at the at least one evaluation signal from the at least one operating signal.

The at least one sensor device communication unit receives the at least one evaluation signal from the at least one signal processing unit, in particular the at least one evaluation unit, as the at least one communication signal. Afterward, the at least one sensor device communication unit communicates the at least one communication signal to the suction apparatus, in particular the at least one suction apparatus communication unit, by means of the at least one communication connection.

Advantageously, the at least one suction apparatus communication unit is provided for receiving the at least one communication signal. The suction apparatus has at least one data processing unit configured to evaluate the at least one communication signal and to control the suction apparatus by open-loop and/or closed-loop control, wherein the at least one communication signal is the at least one evaluation signal. The at least one suction apparatus communication unit is additionally configured to forward, in particular to communicate in a line-linked manner, the at least one communication signal, in particular the at least one evaluation signal, to the at least one data processing unit. The at least one data processing unit is preferably arranged substantially in the suction apparatus housing. The at least one suction apparatus communication unit and the at least one data processing unit are preferably arranged on substantially one printed circuit board. It is also conceivable for the at least one suction apparatus communication unit and the at least one data processing unit to be arranged on at least two printed circuit boards.

The at least one data processing unit receives the at least one evaluation signal as the at least one communication signal and evaluates it. The at least one data processing unit substantially evaluates the at least one item of information about the at least one operating state and/or the at least one operating parameter of the machine tool, in particular of the handheld machine tool, such that the suction apparatus is then controlled by open-loop and/or closed-loop control depending on the content of the at least one evaluation signal. In this case, the suction apparatus is preferably switched on or switched off, wherein it is also conceivable for the suction capacity of the suction apparatus to be controlled by closed-loop control. The at least one data processing unit is a microcontroller and/or microprocessor, for example. The open-loop and/or closed-loop control of the suction apparatus by means of the at least one data processing unit is effected, for example, by way of a current that flows through the suction apparatus drive. This enables the suction apparatus to be controlled by open-loop and/or closed-loop control on the basis of the at least one operating signal. The working convenience and the working speed for the user are therefore increased.

As described in the introduction, the at least one sensor unit detects the at least one operating signal and forwards it to the at least one signal processing unit, where the at least one operating signal is processed into the at least one communication signal.

In a second embodiment of the invention, the at least one signal processing unit is additionally configured to convert the at least one operating signal into at least one filter signal by means of at least one filter unit. The at least one filter unit is provided for forwarding the at least one filter signal as the at least one communication signal to the at least one sensor device communication unit. The at least one signal processing unit additionally has the at least one filter unit. Preferably, the at least one filter unit is arranged substantially in the signal processing unit.

In the second embodiment, too, the at least one sensor unit forwards the at least one operating signal directly and immediately to the at least one signal processing unit. The at least one operating signal is then processed by the signal processing unit, in particular the at least one filter unit, by means of a microprocessor and/or microcontroller, for example. Once the at least one filter unit has received the at least one operating signal, in an at least first filter step at least substantially the at least one operating signal is filtered by means of at least one bandpass filter, for example. In the second embodiment, too, possible interference variables which may be at least partly contained in the at least one operating signal are substantially filtered here. Possible interference variables are as described in the introduction. In the case of negative signal values of the at least one operating signal, the absolute value of the at least one operating signal is formed in an at least second filter step. As a result, the at least one operating signal has substantially positive signal values. In an at least third filter step, the at least one operating signal is then at least partly smoothed. In the second embodiment, too, the smoothing of the at least one operating signal in the at least third filter step is effected by means of the moving average method. After the at least third filter step, the at least one operating signal is converted into the at least one filter signal. The at least one filter unit then forwards the at least one filter signal as the at least one communication signal to the at least one sensor device communication unit. The at least one filter signal thus comprises at least substantially data-reduced information about the at least one operating state and/or the at least one operating parameter of the machine tool, in particular of the handheld machine tool. The at least one filter signal is thus at least one prefiltered operating signal. The filter steps described serve substantially to process the at least one operating signal detected by means of the at least one sensor unit into a stable and unambiguous signal.

A simple and compact sensor device is thus provided. Alternatively, it would be possible to carry out a different order of the filter steps in order to arrive at the at least one filter signal from the at least one operating signal.

Analogously to the first embodiment, in the second embodiment the at least one sensor device communication unit receives the at least one filter signal from the at least one signal processing unit, in particular the at least one filter unit, as the at least one communication signal. The at least one sensor device communication unit then forwards the at least one communication signal to the suction apparatus, in particular the at least one suction apparatus communication unit, by means of the at least one communication connection.

Preferably, the at least one suction apparatus communication unit is provided for receiving the at least one communication signal, and the suction apparatus has at least one data processing unit configured to evaluate the at least one communication signal and to control the suction apparatus by open-loop and/or closed-loop control, wherein the at least one communication signal is the at least one filter signal. The at least one communication signal, in particular the at least one filter signal, is forwarded, in particular communicated in a line-linked manner, to the at least one data processing unit by means of the at least one suction apparatus communication unit. Analogously to the first embodiment, in the second embodiment the at least one data processing unit is preferably arranged substantially in the suction apparatus housing. Substantially, the at least one suction apparatus communication unit and the at least one data processing unit are preferably arranged on substantially one printed circuit board. It is possible for the at least one suction apparatus communication unit and the at least one data processing unit to be arranged on at least two printed circuit boards.

The at least one data processing unit receives the at least one filter signal as the at least one communication signal and evaluates it. The at least one data processing unit evaluates substantially the at least one item of data-reduced information about the at least one operating state and/or the at least one operating parameter of the machine tool, in particular of the handheld machine tool, by means of a microprocessor and/or microcontroller, for example. In addition, the data-reduced information about the at least one operating state and/or the at least one operating parameter affords the advantage that the at least one communication signal was converted into an unambiguous and stable signal.

In at least one first processing step, the at least one data processing unit identifies the at least one item of data-reduced information about the at least one operating state and/or the at least one operating parameter of the machine tool. Afterward, the at least one filter signal is processed further in at least one second processing step by means of an algorithm, such as a Schmitt trigger, for example, in order that the at least one filter signal is present in a data-reduced form. As a result of the at least second processing step, the at least one filter signal then comprises the at least one item of information about the at least one operating state and/or the at least one operating parameter of the machine tool, in particular “switched on” or “switched off”. In an at least third processing step, the suction apparatus is then controlled by open-loop and/or closed-loop control, depending on the content of the filter signal in the data-reduced form. In this regard, the suction apparatus is preferably switched on or switched off, wherein it is also conceivable for the suction capacity of the suction apparatus to be controlled by closed-loop control. A suction apparatus that is controlled by open-loop and/or closed-loop control by means of the at least one operating signal is thus provided. Consequently, the noise emission of the suction apparatus is reduced since the suction apparatus is used in a demand-dependent manner.

The at least one operating signal is an analog signal, such that the at least one operating signal is generated in an analog form by the machine tool, in particular handheld machine tool. The at least one sensor device is designed to detect the at least one operating signal, in particular the analog signal, and to process it into the at least one communication signal. In this case, substantially no conversion of the analog at least one operating signal takes place, such that the at least one communication signal is substantially still an analog signal. The at least one sensor device then communicates the analog at least one communication signal to the suction apparatus, in the analog form. The suction apparatus is provided for detecting the analog at least one communication signal and for processing it further in order to control the suction apparatus by open-loop and/or closed-loop control. It is conceivable for the analog at least one operating signal to be converted substantially into a digital signal. The conversion into a digital signal of the analog at least one operating signal can be carried out substantially by the at least one sensor device or by the suction apparatus. For this purpose, the at least one sensor device can additionally comprise at least one analog/digital converter unit (A/D converter unit). The at least one A/D converter unit converts the analog signal into the digital signal by means of a suitable evaluation algorithm. The functioning and the construction of the at least one A/D converter unit are sufficiently known to the person skilled in the art, for which reason they will not be discussed in greater detail here.

In this case, the at least one A/D converter unit is arranged substantially inside the sensor device housing. Preferably, the at least one A/D converter unit is configured as a separate element of the at least one sensor device. However, it is also conceivable for the at least one A/D converter unit to be comprised by the at least one sensor unit, the at least one signal processing unit, the at least one evaluation unit, the at least one filter unit and/or the at least one sensor device communication unit. It is thus possible for the at least one operating signal to be converted into a digital signal, such that the elements of the at least one sensor device process substantially the digital at least one operating signal. Therefore, the digital at least one operating signal is then processed into the at least one communication signal in digital form. In particular, substantially the at least one evaluation signal or the at least one filter signal is then present in digital form. The suction apparatus then processes the digital at least one communication signal, as a result of which the suction apparatus is then controlled by open-loop and/or closed-loop control.

Alternatively, it is also conceivable for the suction apparatus to have the at least one A/D converter unit. In particular, it is possible for the at least one A/D converter unit to be arranged as a substantially separate element inside the suction apparatus housing or to be comprised at least partly by the at least one suction apparatus communication unit and/or the at least one processing unit. Consequently, the at least one operating signal is processed into the at least one communication signal in analog form by the at least one sensor device and is subsequently communicated to the suction apparatus. Afterward, the suction apparatus then converts the analog at least one communication signal into the at least one communication signal in digital form and evaluates the latter. The digital at least one communication signal is then evaluated in such a way that the suction apparatus is controlled by open-loop and/or closed-loop control, as described in the introduction.

The at least one sensor device thus makes possible for the suction apparatus the autostart function for machine tools, in particular handheld machine tools. In order to activate the autostart function, the user puts the suction apparatus operational control element on the suction apparatus operational control unit and/or the at least one operational control element on the at least one operational control unit of the at least one sensor device at an autostart function position. In the autostart function position, the at least one sensor unit is activated, such that the latter detects the at least one operating signal. Preferably, the at least one sensor device is supplied with voltage, in particular energy, as soon as the suction apparatus is switched on. An activation of the at least one sensor device is effected substantially only if the autostart function position is set by the user. Alternatively, the suction apparatus in the autostart function position enables the voltage supply for the at least one sensor device, such that the at least one sensor device is supplied with energy only in the autostart function position.

As soon as the at least one sensor unit registers the at least one operating signal, a sequence of the steps as described above takes place. As soon as the machine tool, in particular the handheld machine tool, is not being used anymore by the user and the machine tool is generating substantially no operating signal, the at least one sensor unit registers the changed at least one operating signal. The suction apparatus is thereupon switched off by means of the absent at least one operating signal. It is conceivable for the suction drive substantially to have an overrun, for the sucking up of the suction apparatus to be present for a certain period of time in the absence of at least one operating signal. With the autostart function activated, substantially the at least one sensor device is permanently activated, such that the sensor unit substantially permanently monitors a change in the at least one operating signal. A rapid and substantially direct reaction of the at least one sensor device is made possible as a result. The suction apparatus can be controlled directly by open-loop and/or closed-loop control by the substantially permanent activation of the at least one sensor device, in particular of the at least one sensor unit. It would be possible, moreover, for the at least one sensor device to switch into a rest mode as soon as the autostart function has been activated. The at least one sensor device is then configured to wake up from the rest mode as soon as the at least one sensor device, in particular the at least one sensor unit, detects a change in the at least one operating signal. In addition, the user can set at least one trigger threshold value for the activation of the autostart function by way of the at least one operational control unit of the at least one sensor device. In this case, the at least one trigger threshold value is dependent on a signal strength of the at least one operating signal. In this regard, the autostart function is triggered substantially only if a specific signal strength of the at least one operating signal is reached and/or exceeded. This enables the user to trigger the autostart function depending on the machine tool, in particular handheld machine tool, used. The autostart function for machine tools, in particular handheld machine tools, is thus made possible.

Advantageously, the at least one sensor device is configured to control the suction apparatus by open-loop and/or closed-loop control, in particular to alter an operating mode of the suction apparatus if the at least one sensor device registers at least one predefined signal. The suction apparatus substantially comprises the operating modes “switched off”, “switched on” and “autostart”. Preferably, the suction apparatus changes the operating mode from “switched on” to “autostart” as soon as the at least one sensor device registers the at least one predefined signal, wherein the change from “autostart” to “switched on” is also possible. The at least one predefined signal is triggered and/or generated substantially by the user. Preferably, the at least one predefined signal involves the user tapping the at least one sensor device. Further predefined signals that appear to be expedient to the person skilled in the art are also conceivable. An increase in the working speed and a flexible adaptation of the operating mode of the suction apparatus to the requirements of the user are thus made possible.

In addition, a system is proposed, having a suction apparatus according to the invention as described above and having at least one machine tool, in particular handheld machine tool.

Moreover, a method for the open-loop and/or closed-loop control of a suction apparatus, as described above, is proposed. In this case, method steps comprise, at least in a first method step, receiving at least one operating signal of the at least one signal processing unit by means of the at least one sensor unit. As described in the introduction, the at least one sensor unit is configured to detect the at least one operating signal and to transmit it to the at least one signal processing unit. A second method step involves processing the at least one operating signal into at least one communication signal by means of the at least one signal processing unit. In this case, the at least one communication signal can be the at least one evaluation signal or the at least one filter signal. A third method step involves providing at least one communication connection to the at least one suction apparatus communication unit by means of the at least one sensor device communication unit. Preferably, the at least one communication connection is line-linked. A fourth method step involves communicating the at least one communication signal to the at least one suction apparatus communication unit by means of the at least one sensor device communication unit. After the at least one communication signal has been communicated, the at least one communication signal is processed by the suction apparatus and the suction apparatus is controlled by open-loop and/or closed-loop control.

### BRIEF DESCRIPTION OF THE DRAWINGS

The invention is explained below on the basis of preferred embodiments. In the drawings below:

FIG. 1 shows a suction apparatus according to the invention having a suction hose and a sensor device in a perspective view,

FIG. 2 shows the suction apparatus according to the invention in a schematic side view;

FIG. 3 shows a schematic illustration of the sensor device;

FIG. 4 shows a flow diagram for elucidating the sensor device and the autostart function.

### DESCRIPTION OF THE EXEMPLARY EMBODIMENTS

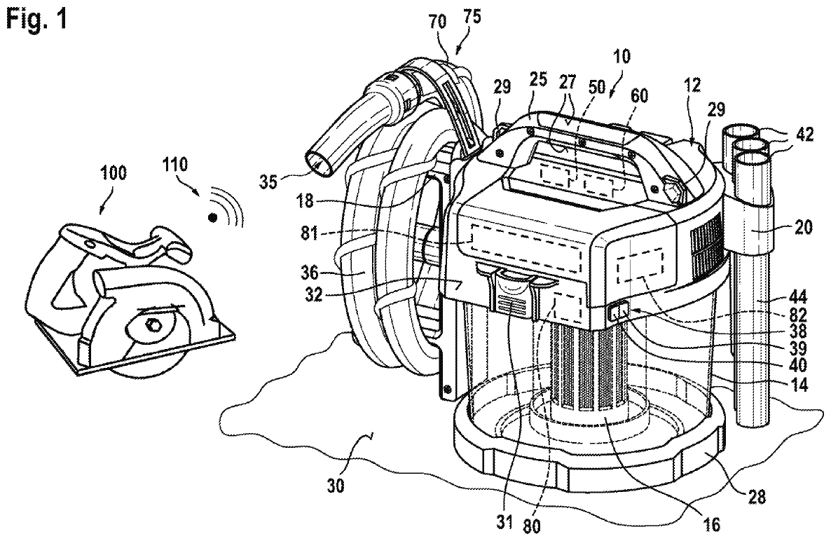

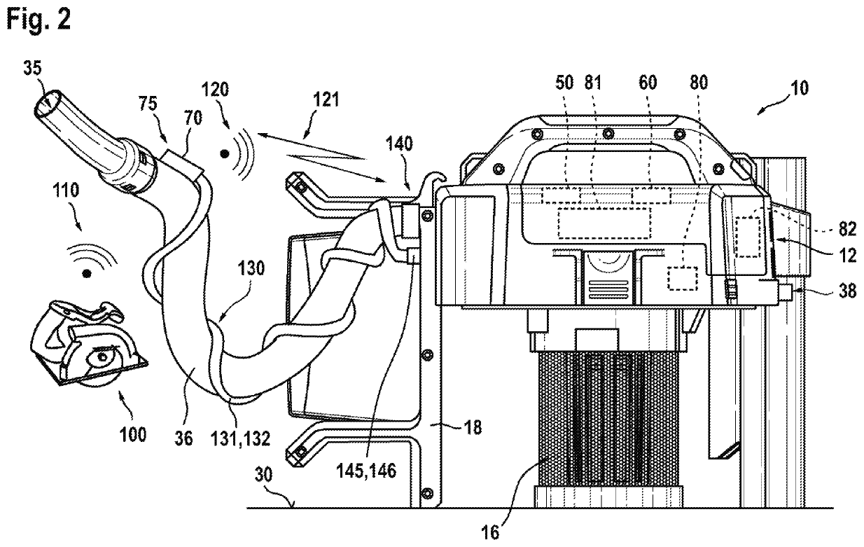

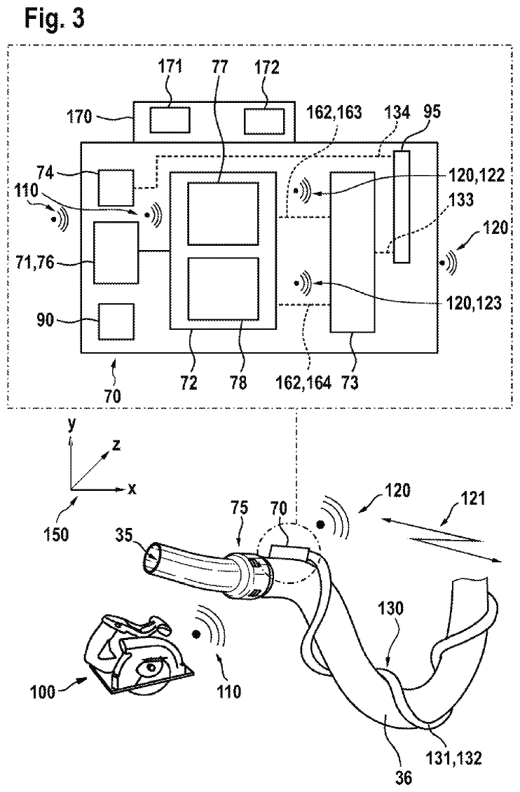

FIG. 1 shows a suction apparatus 10 according to the invention having a suction apparatus housing 12, having a suction hose 36 and having a suction apparatus communication unit 50 in a perspective view. In this configuration of the invention, the suction hose 36 is able to be fitted to the suction apparatus housing 12 in a releasable manner. In this embodiment, the suction apparatus communication unit 50 is arranged substantially in the suction apparatus housing 12. In addition, the suction apparatus 10 has a sensor device 70. The sensor device 70 is arranged on the suction hose 36. The sensor device 70 has a sensor unit 71. The sensor unit 71 detects an operating signal 110 of a machine tool 100, in particular of a handheld machine tool, see also FIGS. 2 and 3. In this configuration, the machine tool 100 is illustrated as an exemplary handheld circular saw. The sensor device 70 comprises a signal processing unit 72 and a sensor device communication unit 73, see also FIG. 3. The signal processing unit 72 receives the operating signal 110 from the sensor unit 71. In addition, the signal processing unit 72 processes the operating signal 110 into a communication signal 120, see also FIGS. 2 and 3. The sensor device communication unit 73 provides a communication connection 121 to the suction apparatus communication unit 50, see also FIGS. 2 and 3. In addition, the sensor device communication unit 73 communicates the communication signal 120 to the suction apparatus communication unit 50, see also FIG. 2 and/or FIG. 3. The suction apparatus 10 has a suction apparatus drive 80, a suction apparatus energy supply unit 81, a dust collecting device 14 and a dust collecting filter element 16. In this case, the suction apparatus housing 12 comprises the dust collecting device 14 and these are connectable to one another releasably by means of at least one locking element 31. The functioning and the cooperation of the suction apparatus drive 80, the suction apparatus energy supply unit 81 and the dust collecting device 14 are sufficiently known to the person skilled in the art. The suction apparatus additionally comprises a data processing unit 60 configured to process the communication signal 120 and to control the suction apparatus 10 by open-loop and/or closed-loop control. The suction apparatus housing 12 is additionally connected to a first accessory carrier 18 and a second accessory carrier 20 in a releasable manner. A suction apparatus holding means 25 has a suction apparatus gripping region 27 and is arranged on the suction apparatus housing 12, in particular on a side of the suction apparatus housing 12, especially particularly on a top side of the suction apparatus housing 12. The suction apparatus gripping region 27 is configured in particular to be enclosed by a hand of the user of the suction apparatus 10. The suction apparatus holding means 25 advantageously enables the suction apparatus 10 to be carried during use or for transport. In addition, the suction apparatus holding means 25 has two securing elements 29. In this embodiment, the securing elements 29 are configured as eyes. The securing elements 29 serve as a possibility for securing, for example for a shoulder strap with two carabiners. The suction apparatus holding means 25 is connected to the housing 12 so as to be immobile relative to the housing 12. It is also conceivable for the suction apparatus holding means 25 to be mounted movably relative to the housing 12, for example in a hinged manner. The suction apparatus housing 12 has a suction apparatus operational control unit 38, wherein the suction apparatus operational control unit 38 comprises a suction apparatus operational control element 39 and a suction apparatus display element 40. The suction apparatus operational control unit 38 is configured to be operated by a user. The user can switch on the suction apparatus 10, switch it off or activate an autostart function by means of the suction apparatus operational control element 39. The suction apparatus display element 40 in this case displays a set operating mode of the suction apparatus 10 to the user. The suction apparatus display element 40 is able to be switched on and/or off by means of the suction apparatus operational control element 39.

The dust collecting device 14 is configured substantially cylindrically, in particular substantially as a truncated cone. The dust collecting device 14 comprises a support element 28 provided for increasing the stability of the suction apparatus 10. A diameter of the contact surface of the suction apparatus 10 is increased by the support element 28. In particular, the contact points of the suction apparatus with a support surface 30 are increased. Furthermore, the support element 28 is designed to increase the ergonomics of the suction apparatus 10. Advantageously, the support element 28 comprises at least one gripping region, which can be configured as a recess, for example. Advantageously, the support element 28 is configured as shock-absorbing; in particular, it is formed from an elastic material for this purpose. Furthermore, it is possible for a suction apparatus movement unit comprising rollers, for example, to be arranged on the support element 28. In an alternative embodiment, it is conceivable for the support element 28 to have a substantially rectangular cross section which matches, in particular is compatible with, existing transport containers, in particular dust collecting devices.

The releasable connection of the suction apparatus housing 12 to the dust collecting device 14 is established via the at least one locking element 31. In this embodiment, the at least one locking element 31 is arranged on a suction apparatus housing exterior 32. The at least one locking element 31 is arranged movably on the suction apparatus housing 12, in particular is connected thereto. Moreover, the at least one locking element 31 establishes a force-locking and positively locking connection between the suction apparatus housing 12 and the dust collecting device 14. In this embodiment, the suction apparatus housing 12 comprises two locking elements 31 arranged opposite one another on the suction apparatus exterior 32 of the suction apparatus housing 12.

Advantageously, the first accessory carrier 18 is provided for mounting the suction hose 36. In particular, the first accessory carrier 18 is configured to mount the suction hose 36 securely, such that the suction hose 36 does not obstruct the user during transport of the suction apparatus 10. In this embodiment, the second accessory carrier 20 comprises three accommodating openings provided for accommodating at least three accessory elements 42. The accessory elements 42 can be configured so as to be able to be fitted into one another, such that more than three accessory elements 42 can be accommodated by the second accessory carrier 20. Preferably, tube elements 44 which are connectable to one another can be accommodated by the accessory carrier 20.

In this embodiment, the suction apparatus 10 is configured as a rechargeable battery-operated suction apparatus which is operated by means of at least one rechargeable battery 82, in particular by means of a handheld machine tool rechargeable battery pack. Consequently, the required energy for the suction apparatus 10 is provided by the at least one suction apparatus energy supply unit 81 by means of the at least one rechargeable battery 82. In addition, the suction apparatus display element 40 is configured as a state of charge display. The state of charge display is configured to display the state of charge of the rechargeable battery 82. Advantageously, the state of charge of the rechargeable battery 82 is able to be displayed by way of the suction apparatus display element 40 during the operation of the suction apparatus 10. In addition, it is conceivable for the suction apparatus display element 40 to display further information concerning the rechargeable battery 82, of the suction apparatus 10 or else the degree of filling of the dust collecting device 14.

The suction hose 36 comprises a suction opening 35 and is able to be fitted to the suction apparatus housing 12 in a releasable manner. The suction opening 35 is designed to take up particles, in particular dirt particles, obtained during the operation of the suction apparatus 10 and to pass them on to the dust collecting device 14 by means of the suction hose 36. The suction hose 36 is connectable to the machine tool 100, in particular the handheld machine tool, in a releasable manner. The suction hose 36 comprises the sensor device 70, wherein the sensor device 70 is arranged, in particular fitted, on an end region 75 of the suction hose 36 and is mechanically connected thereto. In this configuration of the invention, the sensor device 70 is connected to the suction hose 36 by means of a screw connection.

FIG. 2 shows the suction apparatus 10 according to the invention in a schematic side view. The suction apparatus 10, in particular the suction apparatus communication unit 50, is line-linked to the sensor device 70. For this purpose, the suction hose 36 has a line 130 for line linking between the suction apparatus 10 and the sensor device 70. In this embodiment, the line 130 comprises a communication line 131 and an energy supply line 132. The communication line 131 communicates the communication signal 120 between the sensor device 70 and the suction apparatus 10. The energy supply line 132 connects the sensor device 70 to the suction apparatus 10, in particular to the suction apparatus energy supply unit 81, such that the sensor device 70 is supplied with energy.

The suction apparatus housing 12 comprises a mechanical interface 140 and a communication interface 145. The mechanical interface is configured to connect the suction hose 36 to the suction apparatus housing 12, and in particular to the dust collecting device 14, in a releasable manner. This is done substantially by means of a force-locking and/or positively locking connection. The communication interface 145 is provided for connecting the sensor device 70 to the suction apparatus communication unit 50. The communication interface 145 connects the sensor device 70 to the suction apparatus communication unit 50 by means of the communication line 131. In this embodiment, the communication line 131 is releasably connected to the communication interface 145 via a plug connection. In addition, the communication interface 145 is an energy supply interface 146 for the energy supply line 132. The energy supply interface 146 connects the sensor device 70 to the suction apparatus energy supply unit 81 via the energy supply line 132. In an alternative configuration, it is possible for the communication interface 145 to comprise the energy supply interface 146 or to be provided without an energy supply interface 146.

FIG. 3 illustrates a schematic illustration of the sensor device 70. In particular, an enlarged illustration of the sensor device 70 is shown. The sensor device 70 has a sensor device energy supply unit 74, which supplies the sensor device 70 with energy. For this purpose, the sensor device energy supply unit 74 is connected to the energy supply line 132 by means of a plug device 95. The sensor device energy supply unit 74 is connected to the plug device 95 via a line 134, wherein it is also conceivable for a connection between the sensor device energy supply unit 74 and the plug device 95 to be effected via at least one conductor track. In this embodiment, the energy supply line 132 is connectable to the plug device 95 in a releasable manner, wherein the energy supply line 132 has a suitable and compatible plug connection for connection to the plug device 95. As a result, the sensor device energy supply unit 74 supplies the sensor device 70 with energy via the suction apparatus energy supply unit 81. In another configuration, it is also conceivable for the energy supply line 132 to be connected directly and immediately to the sensor device energy supply unit 74, such that the plug device 95 can be dispensed with. Alternatively, it is also possible for the sensor device energy supply unit 74 to be supplied with electrical energy via at least one battery, in particular at least one button cell, via at least one rechargeable battery unit, or by means of energy harvesting.

In this embodiment of the invention, the at least one sensor device 70 has a sensor unit 71. The sensor unit 71 detects the operating signal 110 of the machine tool 100, in particular of the handheld machine tool. In this embodiment, the sensor unit 71 is configured as an acceleration sensor 76 which detects the operating signal 110 of the machine tool 100, in particular the vibrations thereof during operation. The acceleration sensor 76 detects substantially acceleration values of three spatial directions 150. However, further sensor units that appear to be expedient to the person skilled in the art are also conceivable. In this embodiment, the machine tool 100, in particular the handheld machine tool, generates the operating signal 110 during its operation. In this case, the operating signal 110 is the vibration, caused by a rotation of a machine tool motor and/or processing of a workpiece. On account of the connection of the machine tool 100 to the suction hose 36, the sensor unit 71 can detect the operating signal 110.

As described in the introduction, the sensor device 70 additionally has the signal processing unit 72 and also the sensor device communication unit 73. The sensor unit 71 communicates the detected operating signal 110 to the signal processing unit 72. The signal processing unit 72 then processes the operating signal 110 into the communication signal 120, for example by means of at least one microprocessor and/or at least one microcontroller. The communication signal 120 comprises information concerning an operating state of the machine tool 100, in particular of the handheld machine tool, such as, for example, switched on or switched off, or at least one prefiltered signal, or further operating parameters that appear to be expedient to the person skilled in the art. In addition, the signal processing unit 72 communicates the communication signal 120 to the sensor device communication unit 73, in particular in a line-linked manner.

The sensor device communication unit 50 is provided for receiving the communication signal 120 from the signal processing unit 72. The sensor device communication unit 73 provides the communication connection 121 to the suction apparatus communication unit 50. In addition, the sensor device communication unit 73 communicates the communication signal 120 to the suction apparatus communication unit 50, see also FIG. 2. In this embodiment, the communication connection 121 is established in a line-linked manner, in particular via the communication line 131. For this purpose, the sensor device communication unit 73 is connected to the plug device 95 by means of a line 133. In this embodiment, the communication line 131 is connectable to the plug device 95 in a releasable manner by means of a suitable and compatible plug connection. In another configuration, it is also possible for the communication line 131 to be directly and immediately connectable or connected to the sensor device communication unit 73. Alternatively, it is also conceivable for the communication connection 121 to be configured in a wireless manner.

As shown in FIG. 3, the sensor device 70 comprises the sensor unit 71, the signal processing unit 72, the sensor device communication unit 73 and the sensor device energy supply unit 74; in particular, these elements are arranged inside a sensor device housing 79. The sensor unit 71 has a line link 161 to the signal processing unit 72, such that the operating signal 110 is communicated directly and immediately. The signal processing unit 72 processes the operating signal 110 into the communication signal 120. The signal processing unit 72 then transmits the communication signal 120 to the sensor device communication unit 73 by means of a line link 162. The sensor device 70 additionally comprises an operational control unit 170. In addition, the operational control unit 170 has an operational control element 171 and a display element 172. The operational control unit 170 enables the user to operationally control the sensor device 70, in particular to switch it on and off. The operational control unit 170 of the sensor device 70 is likewise provided for providing and displaying an operating state and/or an operating parameter and/or an item of operating information of the sensor device 70 and/or of the suction apparatus 10 for the user. In this case, it would be possible for the operational control unit 170 to indicate whether the sensor device 70 is switched on or off, whether the autostart function is activated, what is the state of charge of the rechargeable battery 82 of the suction apparatus 10, or further items of information that appear to be expedient to the person skilled in the art. Alternatively, it is conceivable for the operational control unit 170 of the sensor device 70 to display the operating state of the machine tool 100. Moreover, the operational control unit 170 of the sensor device 70 is configured to alter operating states and/or operating parameters of the sensor device 70 and/or of the suction apparatus 10 by way of the operational control element 171 and/or the display element 172, in particular to control the sensor device 70 and/or the suction apparatus 10 by open-loop and/or closed-loop control. The operating states and/or operating parameters of the sensor device 70 are for example as described in the introduction. In this embodiment, the operational control unit 170 of the sensor device 70 is arranged on the sensor device housing 79. In addition, the sensor device 70 can comprise an analog/digital converter unit 90 (A/D converter unit). The at least one A/D converter unit 90 converts an analog signal into a digital signal by means of a suitable evaluation algorithm, as described in the introduction.

FIG. 3 schematically illustrates a first embodiment of the invention and also a second embodiment of the invention. In the first embodiment of the invention, the signal processing unit 72 additionally has an evaluation unit 77. The evaluation unit 77 is provided for processing the operating signal 110 into an evaluation signal 122. Afterward, the evaluation unit 77 communicates the evaluation signal 122 as the communication signal 120 to the sensor device communication unit 73 by means of a line link 163. The sensor device communication unit 73 is configured to receive the evaluation signal 122 as communication signal 120 and to transmit the communication signal 120 to the suction apparatus communication unit 50 via the communication connection 121. The suction apparatus communication unit 50 receives the communication signal 120 and forwards it to the data processing unit 60 of the suction apparatus 10 in a line-linked manner. The data processing unit 60 receives the communication signal 120 and evaluates it, as a result of which the suction apparatus 10 is subsequently controlled by open-loop and/or closed-loop control. The data processing unit 60 is arranged substantially in the suction apparatus housing 12.

In the second embodiment of the invention, the signal processing unit 72 additionally comprises a filter unit 78 configured to convert the operating signal 110 into a filter signal 123. The filter unit 78 forwards the filter signal 123 as the communication signal 120 to the sensor device communication unit 73 by means of a line link 164. The sensor device communication unit 73 transmits the communication signal 120 to the suction apparatus communication unit 50 in a line-linked manner via the communication connection 121. The suction apparatus communication unit 50 receives the communication signal 120 and communicates it to the data processing unit 60 of the suction apparatus 10 in a line-linked manner. The data processing unit 60 evaluates the communication signal 120, in particular the filter signal 123, and controls the suction apparatus 10 by open-loop and/or closed-loop control.

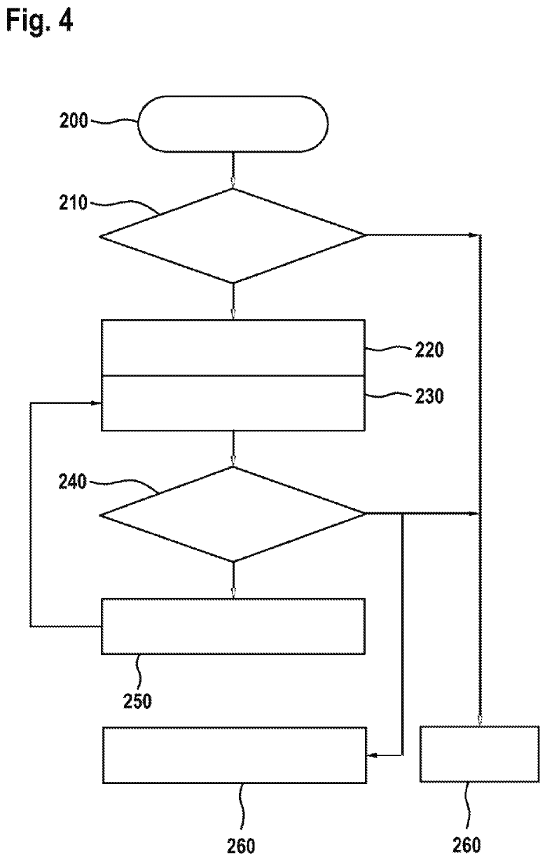

FIG. 4 shows a flow diagram for elucidating the sensor device 70 and the autostart function. The user activates the autostart function 200 by the user fitting the suction apparatus operational control element 39 at an autostart function position 210. As a result, the sensor unit 71 of the sensor device 70 is activated and the sensor unit 71 is in an activated state 220. The sensor unit 71 begins to monitor the machine tool 100, in particular the handheld machine tool, such that the operating signal 110 can be detected. In this case, the sensor unit 71 is then in a monitoring state 230. As soon as the machine tool is in operation 240, the sensor unit 71 detects the operating signal 110 and the suction apparatus 10 is started. In this case, the suction apparatus 10 is then in an activated state 250. During the activated state 250 of the suction apparatus 10, the sensor unit 71 remains in the monitoring state 230 and continues to detect the operation 240 of the machine tool 100. As soon as the machine tool 100 is no longer in operation 240, this change is detected by the sensor unit 71 and the suction apparatus 10 is deactivated 260. In this case, a message to the user about this change of state of the machine tool 100 is then transmitted to the suction apparatus display element 40 and also to the display element 172 of the sensor device 70.

For the case where the suction apparatus operational control element 39 is not at the autostart function position 210, information is likewise communicated to the suction apparatus display element 40 and the display element 172 of the sensor device 70. The user is thereby informed that the sensor device 70 has not yet been activated and the autostart function 200 is not available. In particular, the user is informed that the autostart function position 210 has not yet been set.

1. A suction apparatus comprising:
a suction apparatus housing;
a suction hose;
at least one suction apparatus communication unit; and
at least one sensor device assigned to the suction hose, the at least one sensor device comprising:
at least one sensor unit configured to detect at least one operating signal of a machine tool;
at least one signal processing unit configured to receive the at least one operating signal from the at least one sensor unit and to process the at least one operating signal into at least one communication signal; and
at least one sensor device communication unit configured to provide at least one communication connection to the at least one suction apparatus communication unit and to communicate the at least one communication signal to the at least one suction apparatus communication unit.

2. The suction apparatus as claimed in claim 1, wherein the at least one signal processing unit further comprises at least one evaluation unit configured to convert the at least one operating signal into at least one evaluation signal and to forward the at least one evaluation signal to the at least one sensor device communication unit as the at least one communication signal.

3. The suction apparatus as claimed in claim 1, wherein the at least one signal processing unit further comprises at least one filter unit configured to convert the at least one operating signal into at least one filter signal and to forward the at least one filter signal to the at least one sensor device communication unit as the at least one communication signal.

4. The suction apparatus as claimed in claim 2, further comprising:
at least one data processing unit, wherein:
the at least one suction apparatus communication unit is configured to receive the at least one communication signal,
the at least one data processing unit is configured to evaluate the at least one communication signal and to control the suction apparatus by open-loop and/or closed-loop control, and
the at least one communication signal is the at least one evaluation signal.

5. The suction apparatus as claimed in claim 3, further comprising:
at least one data processing unit, wherein:
the at least one suction apparatus communication unit is configured to receive the at least one communication signal,
the at least one data processing unit is configured to evaluate the at least one communication signal and to control the suction apparatus by open-loop and/or closed-loop control, and
the at least one communication signal is the at least one filter signal.

6. The suction apparatus as claimed in claim 1, wherein the at least one sensor device further comprises at least one operational control unit, which includes at least one operational control element and/or at least one display element.

7. The suction apparatus as claimed in claim 1, wherein the suction apparatus housing comprises:
at least one mechanical interface substantially connecting the suction hose to the suction apparatus housing; and
at least one communication interface substantially connecting at least the at least one sensor device to the at least one suction apparatus communication unit.

8. The suction apparatus as claimed in claim 1, wherein the at least one sensor device is configured to control the suction apparatus by open-loop and/or closed-loop control.

9. The suction apparatus as claimed in claim 1, wherein the suction apparatus is line-linked to the at least one sensor device.

10. A system comprising:
a machine tool; and
a suction apparatus comprising:
a suction apparatus housing;
a suction hose;
at least one suction apparatus communication unit; and
at least one sensor device assigned to the suction hose, the at least one sensor device comprising:
at least one sensor unit configured to detect at least one operating signal of the machine tool;
at least one signal processing unit configured to receive the at least one operating signal from the at least one sensor unit and to process the at least one operating signal into at least one communication signal; and
at least one sensor device communication unit configured to provide at least one communication connection to the at least one suction apparatus communication unit and to communicate the at least one communication signal to the at least one suction apparatus communication unit.

11. A method for open-loop and/or closed-loop control of a suction apparatus, which includes a suction apparatus housing, a suction hose, at least one suction apparatus communication unit, and at least one sensor device assigned to the suction hose, the at least one sensor device including at least one sensor unit, at least one signal processing unit, and at least one sensor device communication unit, the method comprising:
receiving, with the at least one signal processing unit, at least one operating signal of a machine tool from the at least one sensor unit;
processing the at least one operating signal into at least one communication signal with the at least one signal processing unit;
providing at least one communication connection to the at least one suction apparatus communication unit via the at least one sensor device communication unit; and
communicating the at least one communication signal to the at least one suction apparatus communication unit via the at least one sensor device communication unit.

12. The suction apparatus according to claim 1, wherein the machine tool is a handheld machine tool.

13. The suction apparatus according to claim 8, wherein the at least one sensor device is configured to alter an operating mode of the suction apparatus if the at least one sensor device registers at least one predefined signal.

14. The suction apparatus according to claim 9, wherein the at least one suction apparatus communication unit is line-linked to the at least one sensor device.

15. The system according to claim 10, wherein the machine tool is a handheld machine tool.
